(19) United States
(12) Patent Application Publication
(10) Pub. No.: US 2026/0186116 A1
(43) Pub. Date: Jul. 2, 2026

(54) UNDERWATER DETECTION DEVICE, AND UNDERWATER DETECTION DEVICE CONTROL METHOD

(71) Applicant: Furuno Electric Co., Ltd., Nishinomiya (JP)

(72) Inventors: Kazuaki TSUSHIMA, Nishinomiya (JP); Keita TAKARIKI, Nishinomiya (JP); Daisuke NISHIKUBO, Takarazuka (JP)

(21) Appl. No.: 19/549,234

(22) Filed: Feb. 25, 2026

Related U.S. Application Data
(63) Continuation of application No. PCT/JP2024/028285, filed on Aug. 7, 2024.

(30) Foreign Application Priority Data
Aug. 31, 2023 (JP) 2023-141526

(51) Int. Cl. G01S 7/524; G01S 7/62; G01S 15/89

(52) U.S. Cl. CPC G01S 7/524; G01S 7/62; G01S 15/89

(57) ABSTRACT

To provide an underwater detection device capable of operating an ultrasonic transducer with a target transmission power even when the transmission power is set small, the underwater detection device is provided with: a control circuit configured to set a target pulse width corresponding to a transmission power inputted to the ultrasonic transducer and output a control pulse; a Field Effect Transistor (FET) driver configured to output a first voltage signal corresponding to a pulse width of the control pulse; and a power transistor configured to output a second voltage signal that operates the ultrasonic transducer by inputting the first voltage signal. The control circuit is configured to: correct the target pulse width when less than a predetermined threshold value and output the control pulse having the corrected pulse width, and output the control pulse having the target pulse width when the target pulse width exceeds the threshold value.

### CROSS-REFERENCE TO RELATED APPLICATION

This application is a continuation application of PCT International Application No. PCT/JP2024/028285, which was filed on Aug. 7, 2024, and which claims priority to Japanese Patent Application No. JP 2023-141526 filed on Aug. 31, 2023, the entire disclosures of each of which are herein incorporated by reference for all purposes.

### TECHNICAL FIELD

The purpose of this disclosure relates to an underwater detection device for detecting underwater conditions, a method for controlling the underwater detection device, and a program for causing a control circuit of the underwater detection device to perform predetermined functions.

### BACKGROUND

An underwater detection device for detecting underwater conditions is known. In the underwater detection device, an ultrasonic transducer transmits ultrasonic waves into the water, and the ultrasonic transducer receives the reflected waves. An echo data corresponding to the intensity of the received reflected waves are generated, and an echo image is displayed based on the generated echo data.

A user may change the transmit power applied to the ultrasonic transducer under predetermined conditions. For example, the user may reduce the transmit power to prevent ultrasonic interference with other ships when they are nearby. The user may reduce the transmit power to suppress received echo saturation under shallow water conditions.

Such control of transmission power may generally be performed by adjusting the pulse width of a control pulse input from a control circuit to a transmitting circuit.

For example, a power supply voltage is applied to the drain of a power transistor (e.g. Field Effect Transistor: FET), and a voltage signal corresponding to the control pulse is input to the gate of the power transistor via a driver. The pulse-like power supply voltage generated at the source of the power transistor by conduction of the power transistor is boosted by a transformer or the like and applied to an ultrasonic transducer.

In this configuration, the conduction period of the power transistor changes with change in the pulse width of the control pulse. As a result, power of a transmission signal supplied to the ultrasonic transducer changes with a change in the transmission power of the ultrasonic transducer. The transmission power of the ultrasonic transducer is controlled by the pulse width of the control pulse.

However, in a power transistor and a driver, a predetermined period (rising period) is required for an output voltage to stabilize after an input voltage is applied. Therefore, in the above-described configuration, when transmission power of an ultrasonic transducer is low and a pulse width of a control pulse is narrow, the control pulse may fall before an output voltage completely rises, and an actual transmission power may significantly drop from a target transmission power.

### SUMMARY

In view of such problems, an issue to be solved by this disclosure is to provide an underwater detection device capable of operating the ultrasonic transducer with the target transmission power even when the transmission power of the ultrasonic transducer is set to be small, and a method and program for controlling the underwater detection device.

A first embodiment of this disclosure relates to the underwater detection device. The underwater detection device according to the present embodiment comprises a control circuit that outputs a control pulse, a Field Effect Transistor (FET) driver that outputs a first voltage signal corresponding to the control pulse, and a power transistor that outputs a second voltage signal for operating the ultrasonic transducer through conduction upon input to the first voltage signal. The control circuit corrects an actual pulse width from a target pulse width and outputs a control pulse when the target pulse width of the control pulse, set according to the transmission power of the ultrasonic transducer, is equal to or less than a predetermined threshold value. Thus, the reduction of the transmission power is suppressed, and the control pulse is output with the target pulse width when the target pulse width exceeds the threshold value.

According to the underwater detection device of the present embodiment, in a range in which the target pulse width of the control pulse is equal to or less than the threshold value, the actual transmission power may be greatly reduced from the target transmission power due to the influence of the rising period described above. In this range, in order to obtain the desired transmission power by suppressing the reduction of the transmission power, the actual pulse width of the control pulse is corrected from the target pulse width. Thus, even in a range in which the transmission power of the ultrasonic transducer is small, that is, in a range in which the target pulse width is equal to or less than the threshold value, the ultrasonic transducer may be operated with the target transmission power.

In a range where the target pulse width of the control pulse exceeds the threshold value, the actual transmission power does not significantly decrease from the target transmission power, even if the target pulse width is used as it is. In this range, the control pulse is output with the target pulse width. Therefore, the ultrasonic transducer may be operated with the target transmission power in this case as well.

A second embodiment of this disclosure relates to a control method of an underwater detection device comprising a FET driver for outputting a first voltage signal corresponding to a control pulse, and a power transistor for outputting a second voltage signal for operating an ultrasonic transducer by inputting the first voltage signal. The control method according to the embodiment corrects an actual pulse width from a target pulse width and outputs a control pulse when the target pulse width of the control pulse, set according to the transmission power of the ultrasonic transducer, is equal to or less than a predetermined threshold value. Thus, the reduction of the transmission power is suppressed, and when the target pulse width exceeds the threshold value, the control pulse is output with the target pulse width.

A control method according to the embodiment, achieves an effect similar to that of the first embodiment.

The advantageous effect of this disclosure will become clearer from the following description of the embodiments. However, the embodiments described below are merely examples for implementing this disclosure, and this disclosure is not limited to the embodiments described below.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a diagram showing a state of use of a fish finder apparatus according to an embodiment.

FIG. 2 is a block diagram showing a configuration of a fish finder apparatus according to the embodiment.

FIG. 3 is a diagram showing a configuration of a transmitting circuit according to an embodiment.

FIG. 4A is a time chart schematically showing a control pulse when the pulse width is small according to the embodiment. FIG. 4B is a time chart schematically showing a second voltage signal when the control pulse of FIG. 4A is output according to the embodiment. FIG. 4C is a time chart schematically showing a method of correcting the pulse width of the control pulse according to the embodiment.

FIGS. 5A to 5C are diagrams schematically showing a threshold setting method according to the embodiment.

FIG. 6A is a diagram schematically showing a configuration example of reference information according to the embodiment. FIG. 6B is a diagram showing another configuration example of reference information according to the embodiment.

FIG. 7 is a flowchart showing a process when the pulse width of the control pulse according to the transmission power of the ultrasonic transducer according to the embodiment is set.

FIG. 8 is a diagram schematically showing a configuration of the transmitting circuit according to the modified example.

FIG. 9 is a graph schematically showing the relationship between the waveform of the window function (ideal waveform) and the pulse width of the control pulse according to the modified example.

### DETAILED DESCRIPTION

Example apparatus is described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, may be arranged, substituted, combined, separated, and designed in a wide variety of different configurations, all of which are explicitly contemplated herein.

Hereinafter, an embodiment of this disclosure will be described with reference to the drawings. In the following embodiment, a fish finder apparatus is shown as an example of an underwater detection device.

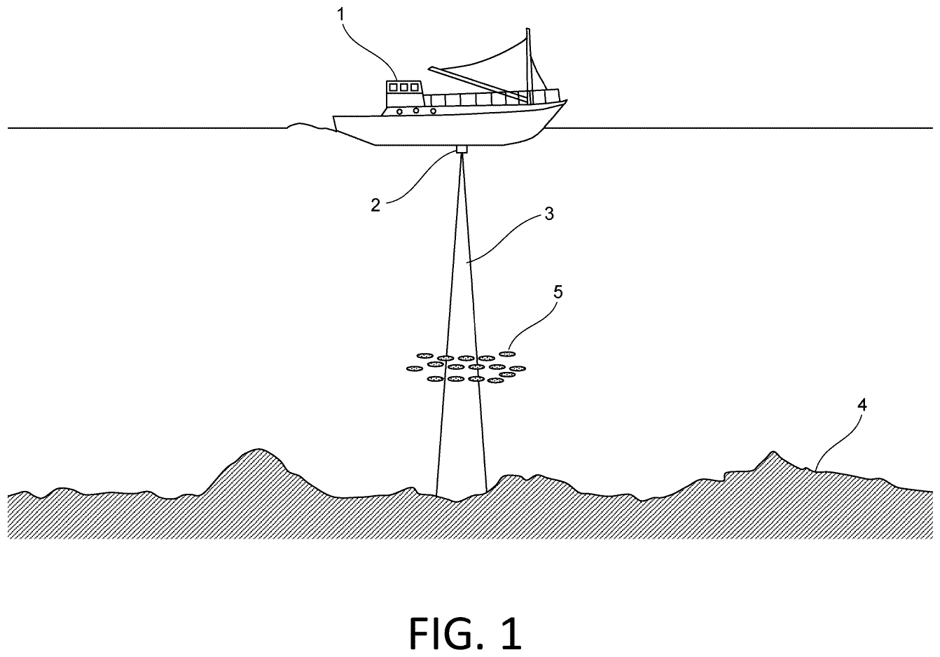

FIG. 1 is a diagram showing a mode of use of an underwater detection device (i.e. a fish finder apparatus 100).

In this embodiment, a transducer 2 is installed on the bottom of a ship 1, and a transmission beam 3 (ultrasonic) is transmitted into the water from the transducer 2. The transmission beam 3 has the shape of a cone with a small apex angle and is transmitted in a pulse shape in the direction directly below the lead. The transmission beam 3 is reflected by a bottom 4 and a fish school 5, and a reflected wave (echo) is received by the transducer 2. An echo data, in which the signal strength (echo strength) of the received signal is distributed in the detection range in the depth direction is generated by the received signal of the reflected wave based on one transmission of the transmission beam 3.

The echo data for a predetermined time are accumulated to generate an echo image showing a distribution of signal intensity (echo intensity) in a depth direction. The echo image includes an intensity distribution of echoes from each target. The generated underwater echo image is displayed on a display unit installed in a wheelhouse or the like of the ship 1. Thus, a user may confirm a target (water bottom 4, fish school 5, etc.) existing underwater.

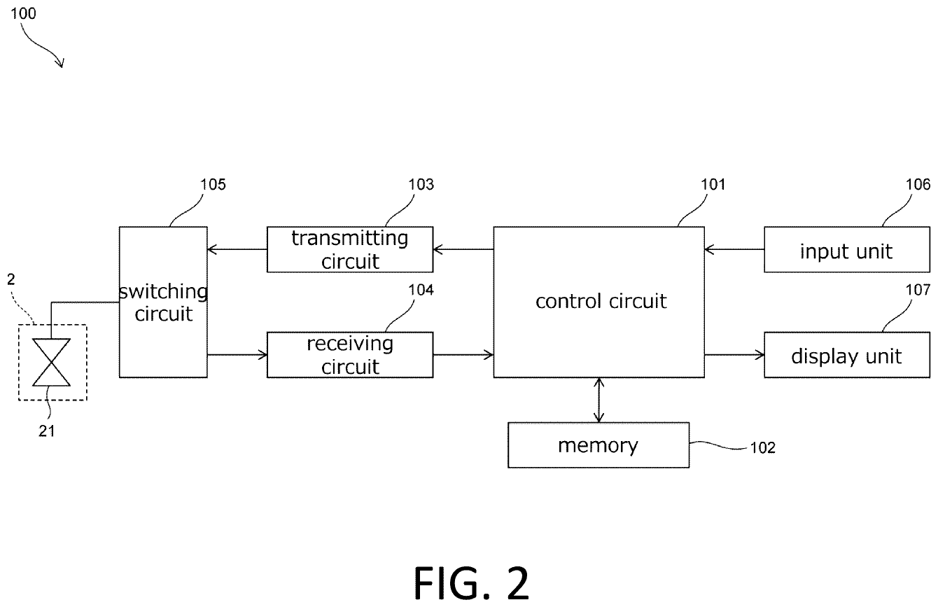

FIG. 2 is a block diagram showing the configuration of the fish finder apparatus 100.

The fish finder apparatus 100 includes, in addition to the transducer 2 shown in FIG. 1, a control circuit 101, a memory 102, a transmitting circuit 103, a receiving circuit 104, a switching circuit 105, an input unit 106, and a display unit 107.

The control circuit 101, the memory 102, the transmitting circuit 103, the receiving circuit 104, the switching circuit 105, the input unit 106, and the display unit 107 are installed in the wheelhouse or the like of the ship 1. The configuration except for the transducer 2 may be unitized in a single housing, or some of the components such as the display unit 107 may be separated. The switching circuit 105 is communicably connected to the transducer 2 by a signal cable.

The transducer 2 includes a transmitting element used for transmitting ultrasonic waves and a receiving element used for receiving ultrasonic waves. In this embodiment, the transmitting element and the receiving element of the transducer 2 are composed of one ultrasonic transducer 21.

The transmitting circuit 103 generates a transmission signal for driving the ultrasonic transducer 21 from a control signal (control pulse) of a predetermined frequency inputted from the control circuit 101, and outputs the generated transmission signal to the ultrasonic transducer 21 of the transducer 2 via the switching circuit 105.

The ultrasonic transducer 21 transmits an ultrasonic (transmission beam 3) into water based on the input transmission signal. The ultrasonic transducer 21 receives a reflected wave of the transmitted ultrasonic wave and outputs a received signal having a size corresponding to the intensity of the reflected wave to the receiving circuit 104 via the switching circuit 105. The switching circuit 105 switches between transmission and reception of signals to and from the ultrasonic transducer 21.

The receiving circuit 104 includes a filter for extracting the frequency component of the transmitted wave from the received signal of the ultrasonic transducer 21 and an amplifier circuit for amplifying the received signal. The receiving circuit 104 generates echo data indicating echo intensity for each depth based on the received signal of the frequency component extracted by the filter.

Specifically, the receiving circuit 104 generates, the echo data, data in which the elapsed time from the timing of transmitting the ultrasonic (transmission beam 3) is associated with the intensity of the reflected wave, and outputs the generated echo data to the control circuit 101.

Here, the elapsed time from the timing of transmitting the ultrasonic corresponds to the depth. The intensity of the reflected wave decreases as the depth increases. Therefore, the receiving circuit 104 corrects the intensity of the reflected wave that attenuates according to the elapsed time, and outputs the echo data in which the intensity is corrected to the control circuit 101.

The control circuit 101 includes an arithmetic processing circuit such as a CPU and an integrated circuit such as an FPGA. The memory 102 includes a ROM, a RAM, a hard disk, and the like. Various programs and information are stored in the memory 102. These programs include a program for causing the control circuit 101 (computer) to execute a function for generating an image by processing the echo data and a function for correcting and setting a pulse width of the control signal (control pulse). The memory 102 is also used as a work area during processing by the control circuit 101. The control circuit 101 controls each section by a program stored in the memory 102.

The input unit 106 includes input means such as a mouse and a keyboard and receives an input from the user. The input unit 106 may be a touch panel integrated with the display unit 107. The display unit 107 includes a display device such as a CRT monitor or a liquid crystal panel, and displays an image generated by the control circuit 101. As described above, the display unit 107 displays an echo image generated based on the echo data.

The control circuit 101 acquires the echo data in which depth is associated with the echo intensity for each transmission timing of the ultrasonic (transmission beam 3). The control circuit 101 generates the echo image based on the echo data for one frame continuously acquired and displays it on the display unit 107. The echo image is sometimes called an echogram.

The echo image is an image in which echo intensity is distributed in a coordinate region having depth and time as two axes. In the echo image, coloring or shading is applied to each pixel in a gradation according to the signal intensity of the reflected wave. A user such as a fisherman may grasp the position and range of a school of fish in the water by referring to the echo image displayed on the display unit 107.

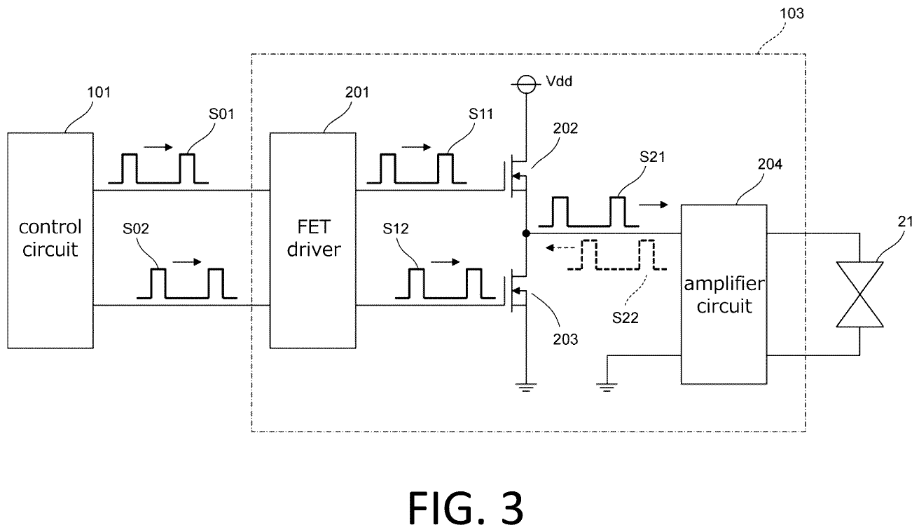

FIG. 3 is a diagram showing the configuration of the transmitting circuit 103.

The transmitting circuit 103 includes a FET driver 201, FETs 202 and 203 (field effect transistors), and an amplifier circuit 204. Two FETs 202 and 203 are connected in series between a power supply voltage Vdd and ground. An amplifier circuit 204 is connected between two FETs 202 and 203.

The control circuit 101 outputs control pulses S01 and S02 for driving the FETs 202 and 203 to the FET driver 201. The control pulses S01 and S02 are voltage pulse signals of the same cycle, and their phases are shifted by half a cycle from each other. The FET driver 201 outputs first voltage signals S11 and S12 obtained by amplifying the input control pulses S01 and S02, respectively, to the gates of the FETs 202 and 203. As a result, the FETs 202 and 203 conduct alternately at a predetermined cycle. The frequencies of the first voltage signals S11 and S12 are the same as the frequencies of the control pulses S01 and S02. Therefore, the operating frequencies of the FETs 202 and 203 are also the same as the frequencies of the control pulses S01 and S02.

When the upper FET 202 is turned on, a second voltage signal S21 for setting the power supply voltage Vdd to a high level is supplied to the amplifier circuit 204. The frequency of the second voltage signal S21 is the same as the frequency of the control pulse S01.

The amplifier circuit 204 includes a voltage conversion circuit such as a transformer. The amplifier circuit 204 raises or lowers the second voltage signal S21 to generate a transmission signal of a predetermined frequency and supplies the generated transmission signal to the ultrasonic transducer 21. As a result, ultrasonic waves are transmitted from the ultrasonic transducer 21.

By conducting the lower FET 203, the second voltage signal S22 is guided to ground from the amplifier circuit 204. The second voltage signal S22 is a voltage signal remaining in a transformer or the like in the amplifier circuit 204 when a transmission signal is generated. As a result, the FETs 202 and 203 are alternately conducted by the first voltage signals S11 and S12, a transmission signal of a predetermined frequency is supplied to the ultrasonic transducer 21, and ultrasonic waves are transmitted from the ultrasonic transducer 21.

By the way, in the fish finder apparatus 100, the transmission power applied to the ultrasonic transducer 21 may be changed under predetermined conditions. For example, the user lowers the transmission power via the input unit 106 of FIG. 2 in a way that ultrasonic interference with other ships does not occur when other ships are nearby. Alternatively, the user lowers the transmission power to suppress the saturation of the received echo in a shallow water condition.

Control of the transmission power as described above, is performed by adjusting the pulse width of the control pulse S01 inputted from the control circuit 101 to the transmitting circuit 103 in the configuration shown in FIG. 3. When the pulse width of the control pulse S01 changes, the pulse width of the first voltage signal S11 changes, and the conduction period of the FET 202 changes. As a result, the pulse width of the second voltage signal S21 changes, and the power of the transmission signal supplied to the ultrasonic transducer 21 changes. The voltage value and pulse width (integral value of the second voltage signal) of the second voltage signal S21 determines power of the transmission signal. Thus, the pulse width of the control pulse S01 controls the transmission power of the ultrasonic transducer 21.

However, in the FET driver 201 and FET 202 shown in FIG. 3, a predetermined period (rising period) is required from the start of application of the input voltage to the stabilization of the output voltage. Therefore, when the transmission power of the ultrasonic transducer 21 is set low and the pulse width of the control pulse S01 is small, the control pulse falls before the output voltages completely rise, and the actual transmission power may greatly decrease from the target transmission power.

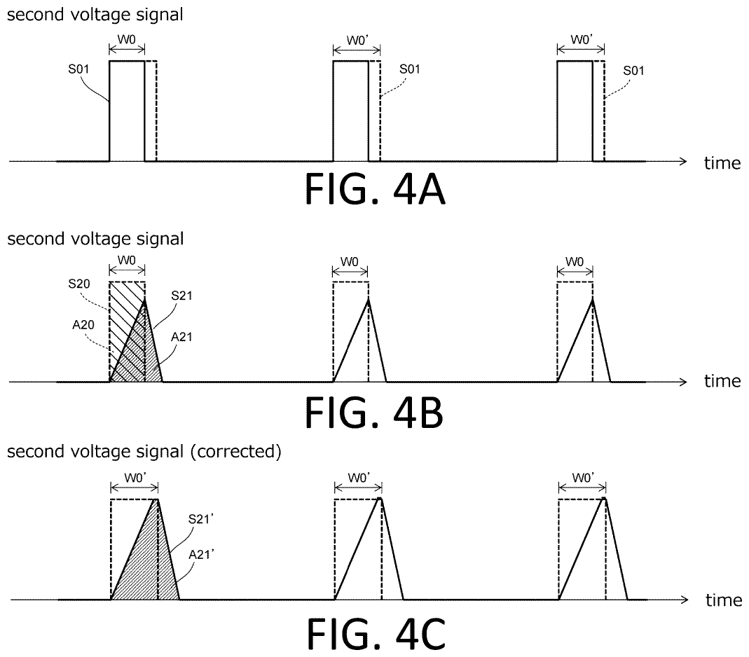

FIG. 4A is a time chart schematically showing the control pulse S01 when the pulse width is narrow, and FIG. 4B is a time chart schematically showing the second voltage signal S21 in this case.

In the example of FIG. 4A, a target pulse width of the control pulse S01, according to the transmission power, is the pulse width W0. The target pulse width is an ideal pulse width, set to obtain the target transmission power.

In this case, ideally, as shown by a broken line in FIG. 4B, a rectangular second voltage signal S20 having the same pulse width as the pulse width W0 is output from the FET 202. However, in practice, a second voltage signal S21 having a waveform shown by a solid line in FIG. 4B is output from the FET 202 due to the rising period and the falling period in the FET driver 201 and the FET 202. In the second voltage signal S21, the left and right slope periods correspond to the rising period and the falling period based on the operating characteristics of the FET driver 201 and the FET 202, respectively.

In this case, the integrated value of the actual second voltage signal S21, that is, an area A21 of the portion surrounded by the second voltage signal S21 and the time axis, is considerably smaller than the integrated value of the ideal second voltage signal S20, that is, an area A20 of the portion surrounded by the second voltage signal S20 and the time axis. Therefore, the target transmission power may not be supplied to the ultrasonic transducer 21 by the second voltage signal S21.

Therefore, in this embodiment, as shown in FIG. 4C, the actual pulse width of the control pulse S01 is corrected from the target pulse width W0 to the pulse width W0′ in a way that the integrated value (area A21′) of the second voltage signal S21′ approaches the integrated value (area A20) of the ideal second voltage signal S20 of FIG. 4B. More specifically, the corrected pulse width W0′ is set in a way that the area A21′ is substantially equal to the area A20. As a result, the second voltage signal S21′ is output from the FET 202 to the amplifier circuit 204. Thus, the ultrasonic transducer 21 may be operated with the target transmission power.

In the present embodiment, such correction is performed when the target pulse width W0 of the control pulse S01 is within a range of a predetermined threshold value or less. Here, the threshold value is set based on the operating characteristics of at least one of the FET drivers 201 and the FET 202.

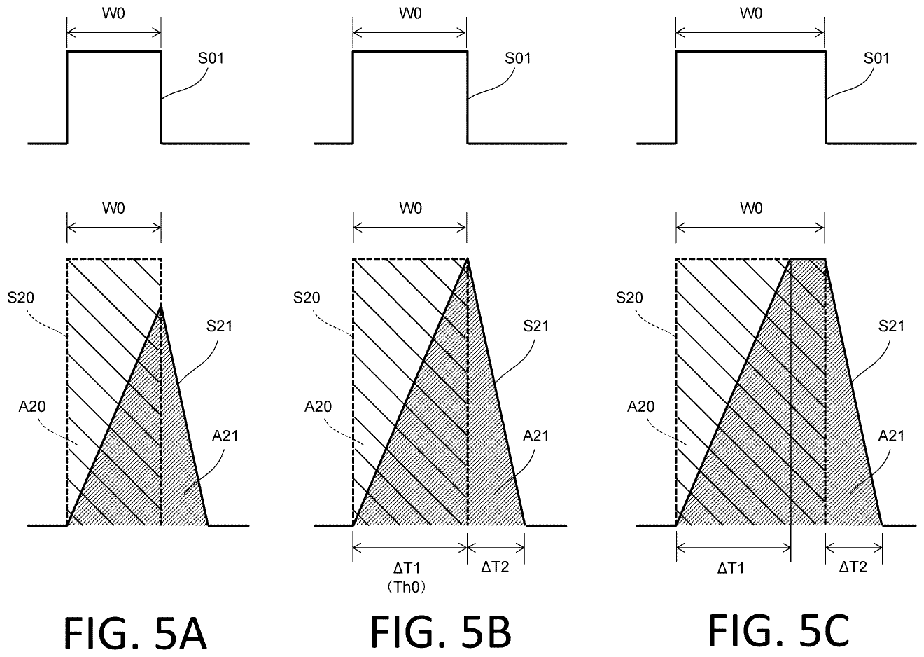

FIGS. 5A to 5C are diagrams schematically showing a threshold value setting method.

Control pulses S01 having target pulse widths W0 different from each other are shown in the upper stages of FIGS. 5A to 5C. The ideal second voltage signal S20 and the actual second voltage signal S21 output from the FET 202, when the control pulse S01 in the upper stage is output from the control circuit 101, are shown in the lower stages of FIGS. 5A to 5C.

The target pulse width W0 in the upper stage is the smallest in FIG. 5A and the largest in FIG. 5C. In FIG. 5B, a rising period ΔT1 of the actual second voltage signal S21 coincides with the pulse width W0. The rising period ΔT1 is based on the operating characteristics of the FET driver 201 and the FET 202.

That is, even when the rectangular control pulse S01 as shown in the upper part of FIG. 5B is input to the FET driver 201, the output of the FET driver 201 does not instantly rise to the high level, but gradually rises to the high level in accordance with the operating characteristic (rising characteristic) of the FET driver 201. When the output of the FET driver 201 is input to the gate of the FET 202, the output of the FET 202 rises more slowly to the high level in accordance with the operating characteristic (rising characteristic) of the FET driver 201.

Thus, the operating characteristic (rising characteristic) of the FET driver 201 and the FET 202 determines the rising period ΔT1, which is the period from when the output of the control pulse S01 is started (when the control pulse S01 changes from the low level to the high level) until the actual second voltage signal S21 reaches the high level. Similarly, the operating characteristic (rising characteristic) of the FET driver 201 and the FET 202 also determines a falling period ΔT2, which is the period from when the output of the control pulse S01 is terminated (when the control pulse S01 changes from the high level to the low level) until the actual second voltage signal S21 reaches the low level. Normally, the rising period ΔT2 is smaller than the falling period ΔT1.

Here, the rising period ΔT1 is dominantly affected by the one having the rising characteristic of the FET driver 201 and the FET 202 which has the longer rising period (the one having the gentler rising gradient). Similarly, the falling period ΔT2 is dominantly affected by the one having the longer falling period (the one having the gentler falling gradient) of the FET driver 201 and the FET 202.

In the example of FIG. 5A, since the target pulse width W0 of the control pulse S01 is narrower than the rising period ΔT1, the output of the control pulse S01 ends before the actual second voltage signal S21 completely rises. Therefore, the actual second voltage signal S21 immediately falls to a low level thereafter. Therefore, in this case, the actual second voltage signal S21 becomes a triangular wave whose peak is smaller than the high level of the ideal second voltage signal S20.

In the example of FIG. 5B, since the target pulse width W0 of the control pulse S01 coincides with the rising period ΔT1, the output of the control pulse S01 ends at the timing when the actual second voltage signal S21 completely rises. Therefore, the actual second voltage signal S21 immediately falls to the low level after completely rising to the high level. In this case, the actual second voltage signal S21 becomes a triangular wave whose peak coincides with the high level of the ideal second voltage signal S20.

In the example of FIG. 5C, since the target pulse width W0 of the control pulse S01 is larger than the rising period ΔT1, the output of the control pulse S01 ends at a predetermined time after the actual second voltage signal S21 completely rises. Therefore, the actual second voltage signal S21 falls to a low level after the predetermined time. Therefore, in this case, the actual second voltage signal S21 becomes a trapezoidal wave whose upper side coincides with the high level of the ideal second voltage signal S20.

Here, the necessity of the correction shown in FIG. 4C is considered. In the case of FIG. 5A, the area A21, which is the integral value of the actual second voltage signal S21, is considerably smaller than the area A20, which is the integral value of the ideal second voltage signal S20. Therefore, the target transmission power may not be supplied to the ultrasonic transducer 21 with the second voltage signal S21. Therefore, in this case, the correction shown in FIG. 4C is necessary.

On the other hand, in the case of FIG. 5C, since the actual second voltage signal S21 is a trapezoidal wave, there is no large difference between the area A21 and the area A20. Therefore, in this case, since the target transmission power may be substantially supplied to the ultrasonic transducer 21, the correction shown in FIG. 4C is unnecessary.

In the case of FIG. 5B, since the actual second voltage signal S21 rises to the high level of the ideal second voltage signal S20, the difference between the area A21 and the area A20 is not as large as in the case of FIG. 5 A. However, due to this difference, the transmission power supplied to the ultrasonic transducer 21 is slightly lower than the target transmission power. Therefore, it is preferable that the correction shown in FIG. 4C is also performed in this case.

From the above consideration, the threshold value Th0 for determining whether or not the correction shown in FIG. 4C is performed may be set to, for example, the time width of the rising period ΔT1 as shown in the lower part of FIG. 5B. That is, when the target pulse width W0 of the control pulse S01 is less than or equal to the time width of the rising period ΔT1 which is the threshold value Th0, the correction shown in FIG. 4C is performed, and the control pulse S01 having the corrected pulse width W0′ is output from the control circuit 101. When the target pulse width W0 is larger than the threshold value Th0, the correction is not performed, and the control pulse S01 having the target pulse width W0 is output from the control circuit 101.

Here, the rising period ΔT1 may be obtained from, for example, data sheets provided by the manufacturers of the FET driver 201 and the FET 202.

In this case, when the rising period of the FET driver 201 on the data sheet is indicated as a period in which the output signal changes to 10˜90% of the high level, that is, as a period of 80% of the total rising period, the rising period of the FET driver may be obtained as a value obtained by dividing the rising period described in the data sheet by 80% (In other words, the rising period on the datasheet multiplied by 1.25). The same applies to the rising period of the FET 202.

As described above, the larger of the rising periods of the FET driver 201 and the FET 202 dominantly affects the rising period ΔT1. Therefore, the rising period ΔT1 may be set as the larger of the rising periods of the FET driver 201 and the FET 202 acquired from the data sheet as described above.

The threshold value Th0 may not necessarily be set equal to the time width of the rising period ΔT1 but may be set slightly larger than the time width of the rising period ΔT1. The threshold value Th0 may be set near the lower limit of the range of the target pulse width W0 in which the target transmission power may be substantially supplied to the ultrasonic transducer 21.

The target pulse width W0 may be set in a way that the target transmission power may be supplied to the ultrasonic transducer 21 in consideration of the fact that the actual second voltage signal S21 becomes a trapezoidal wave.

In this embodiment, reference information is stored in the memory 102 of FIG. 2 in order to perform the correction shown in FIG. 4C.

The reference information is information in which a first parameter value related to the target pulse width W0 is associated with a second parameter value used for the above-described correction. The reference information is information in which a first parameter value is associated with a second parameter value in a range where the target pulse width W0 of the control pulse S01 is equal to or less than the above-described threshold Th0.

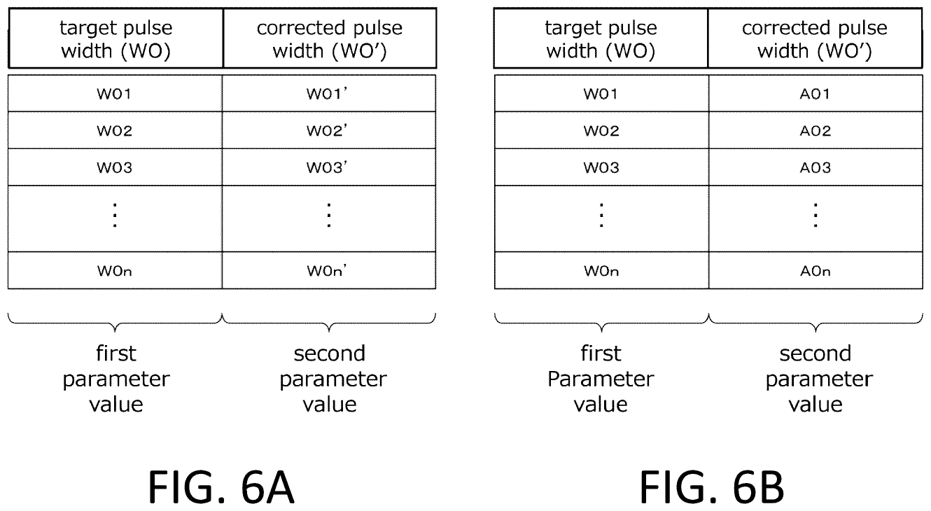

FIG. 6A is a diagram showing the configuration of the reference information.

In FIG. 6A, the target pulse width W0 is set as the first parameter value, and the corrected pulse width W0′ is set as the second parameter value. The target pulse widths W01 to W0n included in the range below the above-described threshold Th0 are registered in the reference information as the first parameter values. These target pulse widths W01 to W0n are target pulse widths that may be selectively used in the fish finder apparatus 100. Corrected pulse widths W01′ to W0n are associated with respective target pulse widths W01 to W0n.

Here, the corrected pulse widths W01′ to W0n′ are set in advance in a way that the integrated value (area A21′) of the second voltage signal S21′ obtained by the corrected pulse widths W01′ to W0n′ matches the integrated value (area A20) of the ideal second voltage signal S20, as described with reference to FIG. 4C. That is, the corrected pulse widths W01′ to W0n′ when the area A21′ matches the area A21 are calculated for each target pulse width W01 to W0n in consideration of the operating characteristics (rising period ΔT1 and falling period ΔT2) of the FET driver 201 and the FET 202. The calculated corrected pulse widths W01′ to W0n′ are associated with the corresponding target pulse widths W01 to W0n.

The first parameter value and the second parameter value are not limited to the target pulse width W0 and the corrected pulse width W0′. For example, as shown in FIG. 6B, the second parameter may be a correction amount for the target pulse width W0. The correction amounts A01 to A0n are differences between the target pulse widths W01 to W0n and the corrected pulse widths W01′ to W0n′ in FIG. 6A. In this case, the corrected pulse widths W01′ to W0n for the target pulse widths W01 to W0n are obtained by adding the correction amounts A01 to A0n to the target pulse widths W01 to W0n, respectively.

The first parameter value may be another value related to the target pulse width W0. For example, the first parameter value may be a magnitude of the transmission power. The second parameter value may be a value for obtaining the corrected pulse width W0′.

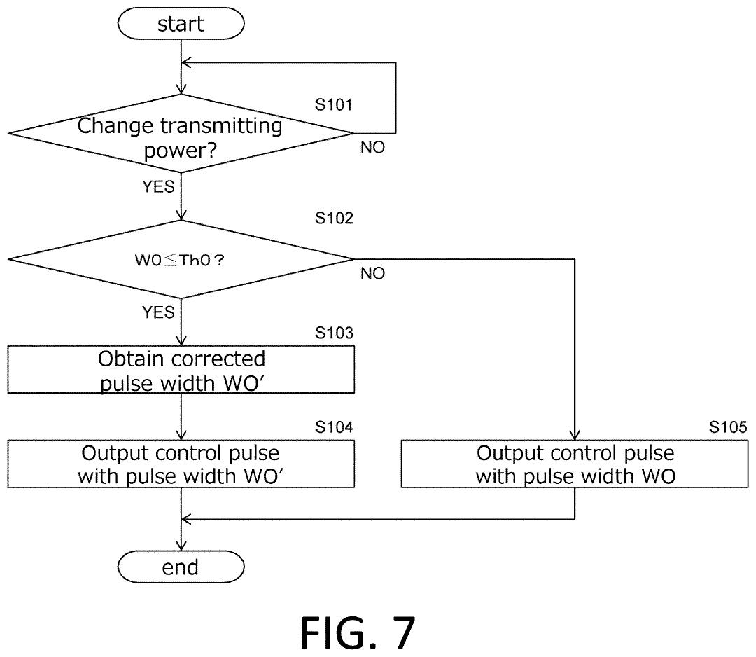

FIG. 7 is a flowchart showing the processing when the pulse width W0 of the control pulse S01 according to the transmission power of the ultrasonic transducer 21 is set.

The control circuit 101 determines whether the transmission power of the ultrasonic transducer 21 has been changed (S101). When an input regarding the change of the transmission power is made via the input unit 106 during the operation of the fish finder apparatus 100, the determination in step S101 is YES. In addition, when the fish finder apparatus 100 is started, that is, when the ultrasonic transducer 21 starts the operation with the initial transmission power, the determination in step S101 is YES. When the determination in step S101 is YES, the control circuit 101 determines whether the target pulse width W0 corresponding to the current transmission power is equal to or less than the above-described threshold value Th0 (S103).

When the target pulse width W0 is equal to or less than the threshold value Th0 (S102: YES), the control circuit 101 acquires the corrected pulse width W0′ corresponding to the current target pulse width W0 from the reference information in FIG. 6 (a) (S103). Then, the control circuit 101 sets the pulse width of the control pulse S01 of the obtained corrected pulse width W0′ and performs an output operation of the control pulse S01 (S104).

On the other hand, when the target pulse width W0 is larger than the threshold value Th0 (S102: NO), the control circuit 101 sets the pulse width of the control pulse S01 of the target pulse width W0 and performs an output operation of the control pulse S01 (S105). When the control circuit 101 sets the pulse width of the control pulse S01 in step S104 or 105, the process ends. Thereafter, the control circuit 101 returns the process to step S101 and performs the same process.

According to the present embodiment, the following effects are achieved.

As shown in FIGS. 4A to 4C and FIG. 7, when the target pulse width W0 of the control pulse S01 is in a range equal to or less than the threshold value Th0, that is, when the target pulse width W0 is used as it is, the actual transmission power may significantly decrease from the target transmission power due to the influence of the rising period ΔT1 in the lower part of FIG. 5B. In this range (S102: YES), the actual pulse width W0′ of the control pulse S01 is corrected from the target pulse width W0, to suppress the decrease and obtain the desired transmission power (Sections 103 and 104). Thus, even in a range where the transmission power of the ultrasonic transducer 21 is small, that is, in a range where the target pulse width W0 is equal to or less than the threshold value Th0, the ultrasonic transducer 21 may be operated with the target transmission power.

In a range where the target pulse width W0 of the control pulse S01 exceeds the threshold value Th0, that is, when the target pulse width W0 is used as it is, the actual transmission power does not significantly decrease from the target transmission power. In this range (S102: NO), the control pulse S01 is output with the target pulse width W0 unchanged. Therefore, also in this case, the ultrasonic transducer 21 may be operated with the target transmission power.

As described with reference to FIGS. 4A to 4C, when the target pulse width W0 is equal to or less than the threshold value Th0, the control circuit 101 performs the above-described correction in a way that the integral value (area A20) of the ideal second voltage signal S20 to be output from the FET 202 (power transistor) when the control pulse S01 is output with the target pulse width W0 and the integral value (area A21′) of the actual second voltage signal S21′ to be output from the FET 202 (power transistor) when the control pulse S01 is output with the actual pulse width W0′ are close to each other.

According to this configuration, since the integral value (area A21′) of the actual second voltage signal S21′ is close to the ideal integral value (area A21), the transmission power of the ultrasonic transducer 21 may be close to the target transmission power. Therefore, the ultrasonic transducer 21 may be operated with the target transmission power.

As shown in FIGS. 2 and 6A and 6B, the fish finder apparatus 100 includes a memory 102 for storing reference information that associates the first parameter value related to the target pulse width W0 with the second parameter value to be used for correction in the range equal to or less than the threshold value Th0. In the processing of FIG. 7, the control circuit 101 acquires the second parameter value (Here, the corrected pulse width W0′) with respect to the current target pulse width W0 from the reference information and performs the above-described correction.

According to this configuration, the pulse width of the control pulse S01 may be corrected by a simple processing such as acquiring the second parameter value from the reference information.

As described with reference to FIGS. 5A to 5C, the threshold value Th0 is set based on the operating characteristics of at least one of the FET drivers 201 and the FET 202 (power transistor).

According to this configuration, since the threshold value Th0 is set based on the operating characteristics of the FET driver 201 or the FET 202 (power transistor), which are the factors that cause the transmission power to fall from the ideal value, the threshold value Th0 may be set appropriately.

As described with reference to FIGS. 5A to 5C, the operating characteristics for setting the threshold value Th0 are, for example, a rising period ΔT1 of the output voltage with respect to the DC input voltage, and the threshold value Th0 is set based on the rising period ΔT1. Specifically, the threshold value Th0 is set substantially the same as the rising period ΔT1.

The rising period ΔT1 shown in FIGS. 5A to 5C substantially corresponds to the pulse width W0 of the control pulse S01 when the control pulse S01 falls at the timing when the second voltage signal S21 output from the FET 202 (power transistor) completely rises. Therefore, when the pulse width W0 of the control pulse S01 is smaller than the rising period ΔT1, the second voltage signal S21 becomes a waveform of a triangular wave that shifts to the falling period ΔT2 before it completely rises, in a way that the transmission power of the ultrasonic transducer 21 drops significantly from the target transmission power. Therefore, the pulse width of the control pulse S01 may be properly corrected by setting a threshold value Th0, that is, a threshold value defining a range for correcting the pulse width of the control pulse S01, based on the rising period ΔT1.

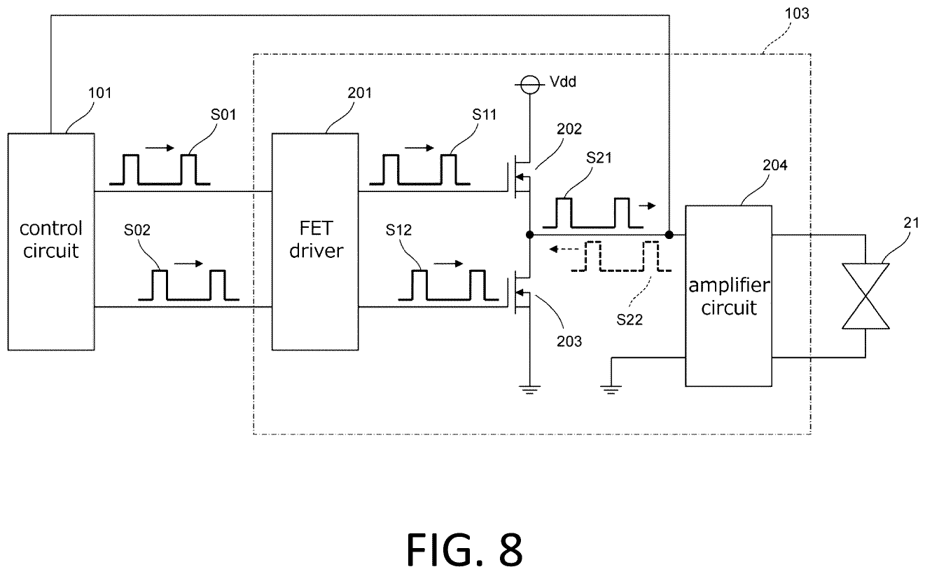

This disclosure is not limited to the above embodiment. The embodiment of this disclosure can be modified in various ways other than the above configuration. For example, in the above embodiment, the corrected pulse width W0′ is obtained using the reference information of FIGS. 6A and 6B, but the method of correcting the pulse width W0 of the control pulse S01 is not limited to this. For example, as shown in FIG. 8, the second voltage signal S21 is fed back to the control circuit 101, and the pulse width W0 of the control pulse S01 may be feedback-controlled in a way that the integrated value (area A21) of the second voltage signal S21 approaches the integrated value (area A20) of the ideal second voltage signal S20.

In this case, the memory 102 stores the integrated value (area A20) of the ideal second voltage signal S20 for each pulse width W0 in the range not exceeding the threshold Th0. The control circuit 101 obtains the integrated value (area A20) corresponding to the current target pulse width W0 through the memory 102. The control circuit 101 controls the pulse width W0 of the control pulse S01 in a way that the integrated value (area A21) of the actual second voltage signal S21 approaches the integrated value (area A20) during the actual operation of ultrasonic transmission. The actual integrated value (area A21) may be an average value of the integrated values (area A21) from the present to several previous ones.

The method of setting the threshold value Th0 is not limited to the methods shown in FIGS. 5A to 5C and may be changed as appropriate. For example, in the above embodiment, the threshold value Th0 is set by using the larger of the rising periods of the FET driver 201 and the FET 202, that is, the one that dominantly affects the rising period ΔT1 of the second voltage signal S21, but the threshold value Th0 may be set in consideration of both the rising periods of the FET driver 201 and the FET 202. Alternatively, the threshold value Th0 may be set by actually measuring the rising period ΔT1 of the second voltage signal S21.

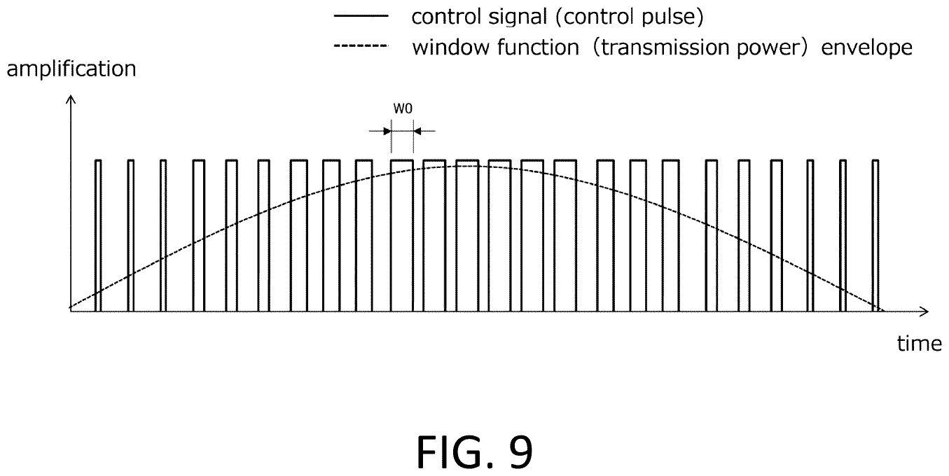

In the above embodiment, the pulse width W0 of the control pulse S01 outputted from the control circuit 101 is constant, but the pulse width W0 may change in one transmission period (ping) as shown in FIG. 9, for example.

In the example shown in FIG. 9, the pulse width W0 of the control pulse S01 is adjusted in a way that the envelope waveform of the transmission wave (transmission power) transmitted in one transmission period becomes a waveform corresponding to a predetermined window function. Thus, the influence of frequency components other than the fundamental wave may be suppressed. As the window function, for example, a Hamming window or a Gaussian window may be used. However, the window function is not limited to these windows. The window function may be appropriately changed according to the purpose.

For convenience, FIG. 9 shows 24 control pulses S01, but the actual number of control pulses S01 is several steps larger. The pulse width W0 of the control pulse S01 increases toward the center of the window function period. Thus, by adjusting the pulse width W0 of the control pulse S01 according to the window function, the transmission wave is transmitted with the transmission power according to the window function.

In this case, for the control pulse S01 whose pulse width W0 is less than or equal to the threshold value Th0, the pulse width is corrected in step S103 of FIG. 7, and for the control pulse S01 whose pulse width W0 is greater than the threshold value Th0, the control pulse S01 is output with the pulse width based on the window function without the correction.

However, in this case, if the threshold value Th0 is set from the same viewpoint as in the above embodiment, a magnitude reversal phenomenon may occur between the corrected pulse width W0′ and the pulse width W0 without correction at the boundary between the application and non-application of the correction. That is, when the pulse width W0 in FIG. 5B is set to the threshold value Th0, the corrected pulse width W0′ (n) is set in a way that the target area A20 is obtained for the pulse width W0 (n) equal to the threshold value Th0.

This pulse width W0′ (n) is larger than the pulse width W0 (n) before the correction. On the other hand, in the next pulse width W0 (n+1), which is expanded from the pulse width W0 (n) in accordance with the above resolution, the pulse width W0 (n+1) remains as the pulse width W0 (n+1) because the correction is not applied. Therefore, when the difference between the pulse width W0 (n) and the pulse width W0′ (n) exceeds the difference between the pulse width W0 (n) and the pulse width W0 (n+1), the corrected pulse width W0′ (n) becomes larger than the pulse width W0 (n+1) without the correction. As a result, an inversion phenomenon occurs in the magnitude of the pulse width before and after the boundary of the threshold value Th0.

When the inversion phenomenon occurs in the magnitude of the pulse width in the control pulses S01 adjacent to each other with the threshold value Th0 as the boundary, the envelope waveform of the transmission power is distorted at the position of these two control pulses S01. Therefore, when the pulse width of the control pulse S01 is changed in one transmission period as shown in FIG. 9, it is preferable to set the threshold value Th0 in a way that the inversion phenomenon does not occur.

Specifically, the threshold value Th0 is set in a way that the difference between the pulse width W0 (n) and the pulse width W0′ (n) does not exceed the difference between the pulse width W0 (n) and the pulse width W0 (n+1) (That is, the difference between the pulse width W0 (n) and the pulse width W0′ (n) is equal to or less than the difference between the pulse width W0 (n) and the pulse width W0 (n+1). That is, the threshold value Th0 is set in a way that the corrected pulse width W0′ (n) of the preceding control pulse S01 of these two control pulses S01 does not exceed the target pulse width W0 (n) of the following control pulse S01. More specifically, the threshold value Th0 is set to a value as small as possible in the range of the threshold value Th0 that may satisfy this condition, and the threshold value Th0 is set near the lower limit of this range. Thus, the inversion phenomenon described above may be avoided, and distortion in the envelope waveform of the transmission wave may be suppressed.

Although the period of the control pulse S01 is constant in the example of FIG. 9, the period of the control pulse S01 may be modulated. That is, the frequency modulated transmission wave may be output from the ultrasonic transducer 21. In this case as well, the threshold value Th0 may be set by the method described with reference to FIG. 9.

In FIG. 2, only one ultrasonic transducer 21 is arranged in the transducer 2, but a plurality of ultrasonic transducers may be arranged in the transducer 2. In this case, the above-described correction processing may be performed for each ultrasonic transducer. Alternatively, when the same FET driver 201 and FET 202 are used for all ultrasonic transducers, the pulse width W0′ after correction may be uniformly set to the pulse width of the control pulse for all ultrasonic transducers.

In the above embodiment, the reference information is stored in the memory 102, but the reference information may be stored in the built-in memory of the control circuit 101.

In the above embodiment, an example in which this disclosure is applied to the fish finder apparatus 100 mounted on the ship 1 is shown, but the application of this disclosure is not limited thereto. For example, this disclosure may be applied to the fish finder apparatus installed in a fixed net, or to an underwater detection device other than the fish finder apparatus such as a scanning sonar.

In addition, various modifications may be made to the embodiments of this disclosure as appropriate within the scope of the claims.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. An underwater detection device, comprising:
a control circuit configured to:
set a target pulse width corresponding to a transmission power inputted to an ultrasonic transducer; and
when the target pulse width is less than a predetermined threshold value;
correct the target pulse width; and
output a control pulse having the corrected pulse width;
a Field Effect Transistor (FET) driver configured to output a first voltage signal corresponding to a pulse width of the control pulse; and
a power transistor configured to output a second voltage signal that operate the ultrasonic transducer by inputting the first voltage signal.

2. The underwater detection device according to claim 1, wherein:
the control circuit is configured to widen the target pulse width when the target pulse width is less than a predetermined threshold value and output the control pulse having the changed pulse width.

3. The underwater detection device according to claim 1, wherein:
the control circuit is configured to make the integral value of an ideal second voltage signal, to be output from the power transistor, closer to the integral value of an actual second voltage signal, to be output from the power transistor, by correcting the target pulse width, when the target pulse width is less than a predetermined threshold value.

4. The underwater detection device according to claim 1, further comprising:
a memory configured to store a first parameter value to set the target pulse width and a second parameter value to correct the target pulse width which is associated to the first parameter value in a range equal to or less than the predetermined threshold value;
wherein the control circuit is configured to correct the target pulse width based on the second parameter value corresponding to the actual target pulse width.

5. The underwater detection device according to claim 1, wherein:
the predetermined threshold value is configured to set based on the operating characteristics of the FET driver.

6. The underwater detection device according to claim 1, wherein:
the predetermined threshold value is configured to set based on the operating characteristics of the power transistor.

7. The underwater detection device according to claim 6, wherein:
the predetermined threshold value is configured to set based on the rising period of output voltage with respect to the power transistor.

8. The underwater detection device according to claim 1, wherein:
the control circuit is configured to continuously output control pulses in which a target pulse width gradually widens and thereafter the target pulse width gradually decreases within a predetermined period.

9. The underwater detection device according to claim 8, wherein:
the transmission power has an envelope waveform based on a predetermined window function.

10. An underwater detection device control method, comprising:
setting a target pulse width corresponding to a transmission power inputted to an ultrasonic transducer; and
when the target pulse width is less than a predetermined threshold value;
correcting the target pulse width;
outputting the control pulse having the corrected pulse width;
outputting a first voltage signal corresponding to a pulse width of the control pulse; and
outputting a second voltage signal that operate the ultrasonic transducer by inputting the first voltage signal.

11. The underwater detection device control method according to claim 10, wherein:
widening the target pulse width when the target pulse width is less than a predetermined threshold value and output the control pulse having the changed pulse width.

12. The underwater detection device control method according to claim 10, wherein:
making the integral value of the second voltage signal to be output from the power transistor closer to the integral value of an actual second voltage signal to be output from the power transistor, by correcting the target pulse width, when the target pulse width is less than a predetermined threshold value.

13. A non-transitory computer-readable medium having stored thereon computer-executable instructions which, when executed by a computer of an underwater detection device cause the computer of the underwater detection device to execute a function of:
setting a target pulse width corresponding to a transmission power inputted to an ultrasonic transducer; and
when the target pulse width is less than a predetermined threshold value;
correcting the target pulse width;
outputting the control pulse having the corrected pulse width;
outputting a first voltage signal corresponding to a pulse width of the control pulse; and
outputting a second voltage signal that operate the ultrasonic transducer by inputting the first voltage signal.
